(19) United States
(12) Patent Application Publication
(10) Pub. No.: US 2022/0301011 A1
(43) Pub. Date: Sep. 22, 2022

(54) Media Clearinghouse

(71) Applicant: Productive Application Solutions, Inc., Sheridan, WY (US)

(72) Inventors: Gerald Maliszewski, San Diego, CA (US); Peter Ta, Tucson, AZ (US)

(21) Appl. No.: 17/830,412

(22) Filed: Jun. 2, 2022

Related U.S. Application Data
(63) Continuation-in-part of application No. 17/230,008, filed on Apr. 14, 2021, now Pat. No. 11,270,349.
Application No. 17/230,008 is a continuation-in-part of application No. 17/201,419, filed on Mar. 15, 2021.
Application No. 17/201,419 is a continuation-in-part of application No. 17/179,574, filed on Feb. 19, 2021, now Pat. No. 11,257,120.
Application No. 17/179,574 is a continuation-in-part of application No. 17/168,313, filed on Feb. 5, 2021.
Application No. 17/168,313 is a continuation-in-part of application No. 17/133,722, filed on Dec. 24, 2020, now Pat. No. 11,055,743.
Application No. 17/133,722 is a continuation-in-part of application No. 17/097,256, filed on Nov. 13, 2020.
Application No. 17/097,256 is a continuation-in-part of application No. 17/071,043, filed on Oct. 15, 2020, now Pat. No. 11,037,199.
Application No. 17/071,043 is a continuation-in-part of application No. 17/023,546, filed on Sep. 17, 2020, now Pat. No. 10,991,007.
Application No. 17/023,546 is a continuation of application No. 17/007,575, filed on Aug. 31, 2020.
Application No. 17/007,575 is a continuation of application No. 16/869,696, filed on May 8, 2020, now Pat. No. 10,803,488.
Application No. 16/869,696 is a continuation of application No. 16/601,362, filed on Oct. 14, 2019, now Pat. No. 10,796,340.
(60) Provisional application No. 62/779,972, filed on Dec. 14, 2018.

(51) Int. Cl. G06Q 30/02

(52) U.S. Cl. CPC G06Q 30/0266; G06Q 30/0252; G06Q 30/0267; G06Q 30/0244

(57) ABSTRACT

A media distribution clearinghouse system is provided with a site selection subsystem having a site table listing a plurality of potential geographic locations, and an interface to accept value weighted geographic location selections and to supply a media enablement signal to a media unit in response to the selected geographic location, so that a media message is displayed at the selected geographic location. The media units may be stationary or mobile. The site table lists locations may be fixed stationary locations, predetermined travel routes, or non-predetermined travel routes. A media message subsystem includes a message table listing a plurality of media messages, and an interface to accept media message selections and supply the media message enablement signal for a selected media message, to the media unit. In some aspect the media message subsystem has an interface to transmit the selected media message to the media unit.

### RELATED APPLICATIONS

Any and all applications, if any, for which a foreign or domestic priority claim is identified in the Application Data Sheet of the present application are hereby incorporated by reference under 37 CFR 1.57.

### BACKGROUND OF THE INVENTION

### 1. Field of the Invention

This invention generally relates to media presentation and, more particularly, to systems and methods for the in-situ management of media messages.

### 2. Description of the Related Art

Market research shows that outdoor billboard marketing space has increasingly become harder to find and, hence, more valuable. At the same time, automotive vehicles are one of the most costly expenses incurred by the average consumer. Ironically, most automobiles sit idle for a large portion of the day. U.S. Pat. No. 10,796,340, entitled SYSTEM AND METHOD FOR TARGETING THE DISTRIBUTION OF MEDIA FROM A MOBILE PLATFORM, invented by Peter Ta et al., and filed on Oct. 14, 2019, addresses to problem of finding more outdoor advertising space by providing an automotive targeted parking system that adds to an automobile the additional feature of a media display subsystem, and which may also include a Wireless Local Area Network (WLAN) IEEE 802.11 (WiFi) access point (hotspot).

While the above-described system addresses the provision of additional outdoor advertising through the “gig economy” use of automobiles, the act of parking remains a potential issue. Parking in many desirable advertising locations in metropolitan areas is often limited to one or two hours only. Further, the necessity of frequently changing parking spots can become a burden and may make the use of their automobile as a mobile media center impractical for some owners.

Parent U.S. Pat. No. 10,991,007, entitled AERIAL BILLBOARD, invented by Peter Ta et al., and filed on Sep. 17, 2020, provides for the use of aircraft, such as unmanned aerial vehicles (UAVs), as another type of media platform.

Parent U.S. Pat. No. 11,037,199, entitled SYSTEM AND METHOD FOR GIG VEHICLE PARKING, invented by Peter Ta et al., and filed on Oct. 15, 2020, describes a publically accessible access point that reports its enablement and position at a targeted parking position.

Parent U.S. Pat. No. 11,138,634, entitled GIG VEHICLE PARKING, invented by Peter Ta et al., with a filing date of May 6, 2021, describes a system that permits agents to deliver selected mobile platforms to corresponding locations.

Parent U.S. Pat. No. 11,138,635, entitled MOBILE MEDIA TOPPER, invented by Peter Ta et al., with a filing date of May 10, 2021, describes a media projection topper that receives a reward in response to reporting the durations of time that a media-presenting vehicle is stationary.

Parent U.S. Pat. No. 11,138,635, entitled SYSTEM AND METHOD FOR COORDINATED MOBILE MEDIA PROJECTION, with a filing date of Feb. 19, 2021, describes a system for coordinated multiple media projection system to present an integrated display from selected parking locations.

Parent Ser. No. 17/230,008, entitled PORTABLE BILLBOARD, filed on Apr. 14, 2021, provides a portable media projection subsystem that reports its enablement and stationary location at a selected weighted value target location.

It would be advantageous if the selection and placement of mobile media messages could be organized more efficiently. It would also be advantageous if media message organization could be performed in real-time. It would be advantageous if a media client had greater control over the media message, the message platform, and the message location.

### SUMMARY OF THE INVENTION

A system and method are disclosed herein for an online dashboard that permits a media client to select media characteristics such as the location for the presentation of a media message, the media message itself, message platform mobility, the type of media platform, and the time of presentation. The system determines rewards associated with the above-mentioned selections, and also permits the client user to add new messages and locations to an online clearinghouse site.

The media projection subsystems disclosed herein can be distinguished from conventional signage in their ability the measure the efficacy of the projected media, and/or access point (AP) communications, and/or cellular boosted communications. One measurement is location, as some locations attract more attention than others. Another measurement is actual enablement, meaning the times and duration that the media is actually seen by the public. To encourage efficient deployment, the entities contracting for, or managing the media projection subsystems, are rewarded based upon these efficacy measurements. Typically being portable, the media projection subsystems may act as an advertising platform that seeks to expand and capture market share within the outdoor advertising market segment by directing the selective deployment of media to preferred target locations. The system may transmit the following information: (i) a unique identifier for the device in use (for example, radio-frequency identification), (ii) the time, date, duration, and location (using global positioning satellite (GPS) or cellular triangulation systems), (iii) an indication that the media projection subsystem has been deployed, and (iv) an indication that the WLAN/WPAN access point, cellular booster, or Internet booster is in use. Graphic information system (GIS) mapping technology may be used to compensate a person or business entity associated with the system for operating in specified locations.

Accordingly, a media distribution clearinghouse system is provided with a site selection subsystem having a site table listing a plurality of potential geographic stationary locations, an interface to accept geographic stationary location selections, and interface to supply a media enablement signal to a media unit in response to the selected geographic stationary location, so that a media message is displayed at the selected geographic stationary location. The media units may be stationary or mobile. The site table lists locations that may be variable locations (dependent on criteria outside of the direct control of the selector), fixed stationary locations, predetermined travel routes, or non-predetermined travel routes.

A media message subsystem includes a message table listing a plurality of media messages, an interface to accept media message selections, and an interface to supply the media message enablement signal, for a selected media message, to the media unit. In some aspects the media message subsystem has an interface to transmit the selected media message to the media unit. In this case the media unit media projection subsystem is likely digital (e.g., a light emitting diode (LED) display panel with attached memory able to accept and display downloaded messages). Alternatively, the media message subsystem table cross-references media messages locally stored on media units. In this case the media projection subsystem may be a printed screen with a single message or a digital display with limited communication ability.

In one aspect the system includes a calendar subsystem with a time table listing a plurality of times, an interface to accept time selections, and an interface to supply a selected time to the media unit. Optionally, a targeting subsystem is included with a valuation table cross-referencing geographic locations to weighted values, with an interface to accept the geographic location selections, and an interface to supply reward calculations in response to the selected geographic location. Alternatively, or in addition, the reward calculations may be based on additional considerations such as time, media message, local (e.g., temporary) environment conditions, and media unit type. In another aspect, a platform subsystem includes a media unit table listing a plurality of media unit types, with an interface for accepting a media unit type selection, and an interface to supply a media unit enablement signal to a selected media unit type. The media unit types may be ground vehicles, air vehicles, nautical vehicles, or stationary billboards.

In some variations, the site selection subsystem has an interface that accepts geographic location suggestions from a user for addition to the site table. Likewise, the media message subsystem may have an interface to accept media message uploads from a user for addition to the message table.

Also disclosed are a system and method for updating the weighted value of a geographic location based upon local environmental factors, a system and method for assigning media projection subsystems to parking locations, and a system and method for a publically accessible cellular telephone or Internet booster.

Additional details of the above-described systems and associated methods are provided below.

### BRIEF DESCRIPTION OF THE DRAWINGS

FIGS. 1A through and 1G are a schematic block diagram and tables depicting a media distribution clearinghouse system.

FIG. 2 is a schematic block diagram depicting an exemplary media unit.

FIG. 3 is a plan view of geographic regions cross-referenced to the weighted value of various positions.

FIG. 4 is a schematic block diagram depicting a system for location value weighting.

FIG. 5 is a flowchart illustrating a media distribution clearinghouse method.

FIG. 6 is a flowchart illustrating a method for establishing location value weighting.

FIG. 7 is a flowchart illustrating a method for assigning locations to mobile platforms.

FIG. 8 is a flowchart illustrating a method for locally boosting cellular telephone network coverage.

### DETAILED DESCRIPTION

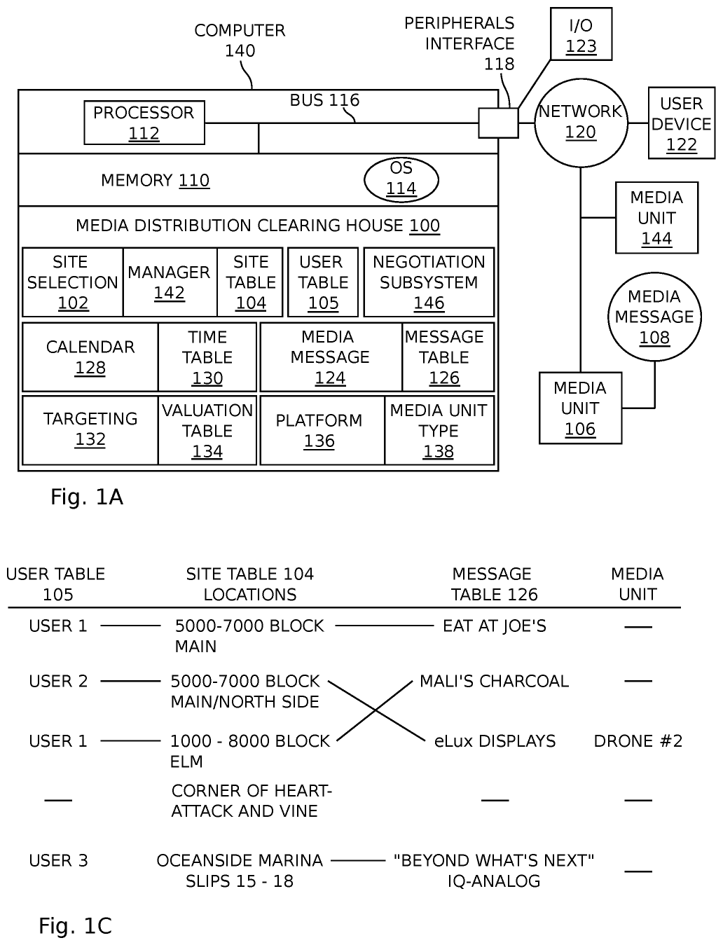

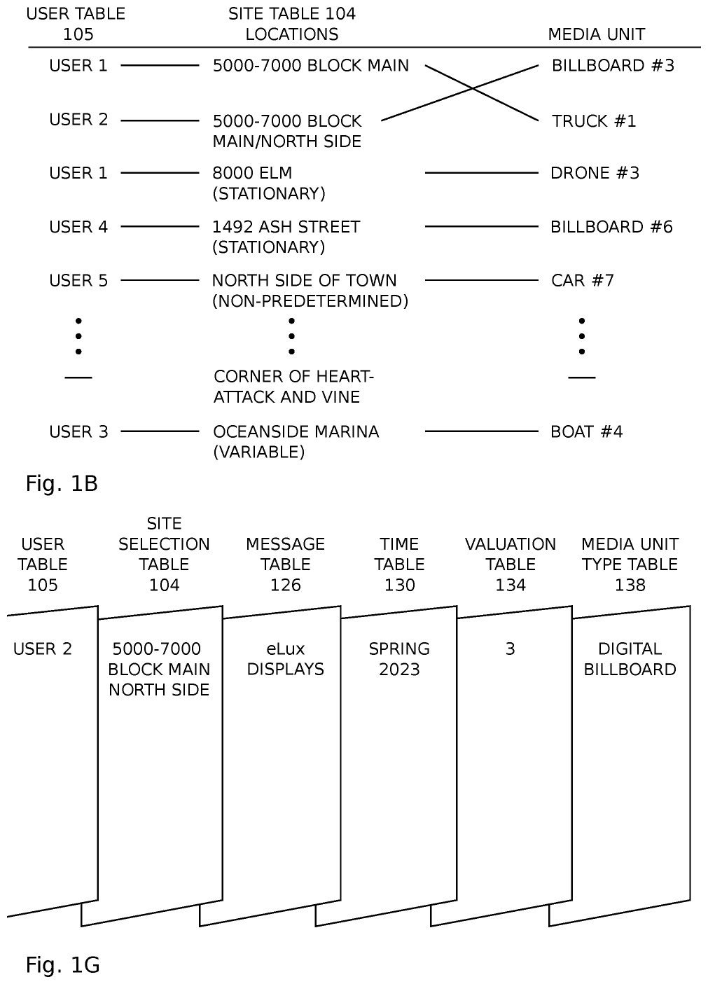

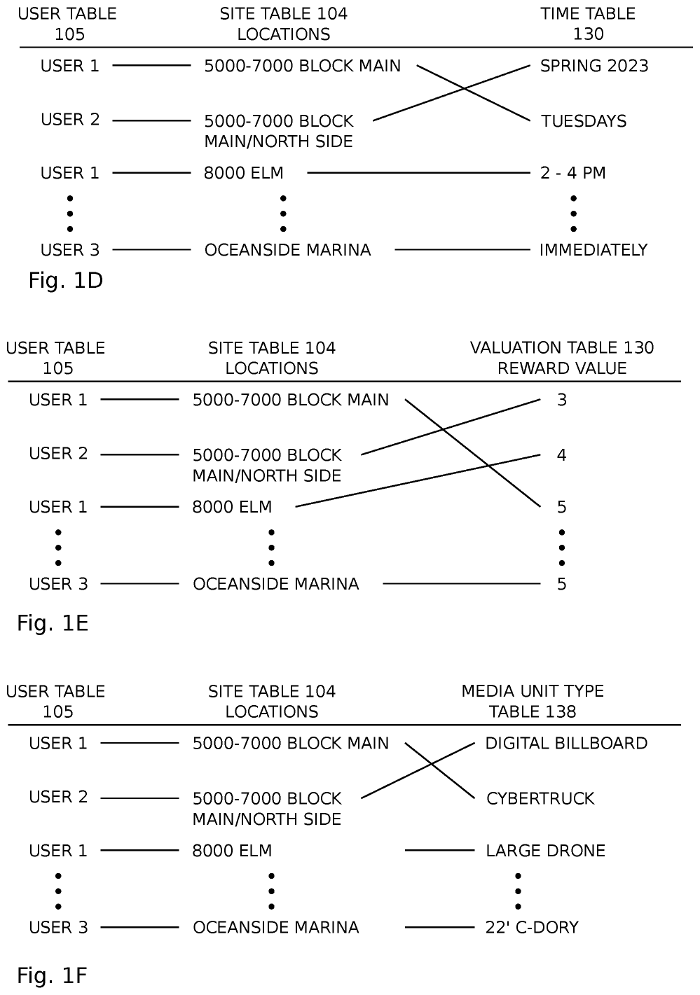

FIGS. 1A through and 1G are a schematic block diagram and tables depicting a media distribution clearinghouse system. The media distribution clearinghouse system 100 comprises a site selection subsystem 102, which comprises a site table 104 listing a plurality of potential geographic locations. The site table 104 is shown cross-referenced to a user table 105 and media units. In some aspects the geographic locations are stationary, and in other aspects they are parking or stationary locations. A site selection subsystem 102 interface accepts geographic location selections and supplies a media enablement signal to a media unit 106 in response to the selected geographic location. Typically, the system involves a plurality of media units, which may be mobile media units, such as ground vehicles, air vehicles, and nautical vehicles, or stationary media units, such as billboards. Oftentimes, the clearinghouse acts as a financial intermediary between users (e.g., advertisers) accessing the site selection table and the media units.

The result is a media message 108 displayed at the selected geographic location. As shown, the media distribution clearinghouse system 100 and site selection subsystem 102 are enabled as a sequence of processor executable instructions stored in non-transitory memory 110. As is the case with the other types of tables presented below, the tables can alternatively be enabled with combinational hardware logic, or even be enabled as physical elements (e.g., paper or blackboards) managed by human operators. However, software enablement is likely to be the most efficient means of management. Thus, the overall system includes a processor 112 and an operating system (OS) 114 stored in memory 110. The site selection subsystem interface is enabled through a system bus 116, connected to the memory 110, the processor 112, a peripherals interface 118, and a network 120. The network 120 may consist of hardwired (e.g., Ethernet), as well as wireless links (e.g., cellular, WiFi, and Bluetooth). The network 120 is connected to a user device 122 (e.g., a smartphone or desktop computer), which may be the source of the location selections. In some cases the location selections may be sourced by the media unit 106, or by a locally connected peripheral input/output (I/O) subsystem 123 (e.g., a display, mouse, and keyboard).

As shown in FIG. 1B, the various users (clients) or media units (driver or media unit owner) have selected locations, and have cross-referenced them to selected media units. The site table 104 may list variable locations, fixed stationary locations, predetermined travel routes, and non-predetermined travel routes. For example, the “Oceanside Marina” location may be considered a variable location based upon tides, local boat traffic, and the boat captain's judgement. The selection of a variable location may entail the acquiescing to one of several possible locations in a certain regions, a best effort to find an available location near a desired location, or a best effort to find an available location guaranteed to be within a predetermined radius of a desired location. Billboard #6 is a fixed stationary location at 1492 Ash Street. In contrast, the location 5000-7000 Main/north side is assigned to any billboard in that range of addresses. 5000-7000 Main (any side), assigned to truck #1, is a predetermined travel route. The “North Side of Town” is a non-predetermined route assigned to car #7, which may be assigned to a free-roaming taxi for example. Another optional feature is that the site selection subsystem 102 accepts geographic location selections from a user (e.g., user device 122 or media unit 106) permitting the user to add a geographic location to the site table 104. In this example, the media units are already located before the user makes location selections. In some aspects, as described below in the explanation of FIG. 1F, the user is also able to select the type of media unit as well as location.

As shown in FIGS. 1A and 1C, the system may further comprise a media message subsystem 124 with a message table 126 listing a plurality of media messages. The media message subsystem accepts media message selections and supplies the media message enablement signal, for a selected media message, to the media unit 106. In one aspect, the media message subsystem 124 transmits the selected media message to the media unit. In this case, the media unit 106 may be equipped with a local memory to store the received massage and a display device, such as a light emitting diode (LED) or liquid crystal (LC) display that is able to project still images or video messages stored in local memory. Alternatively, or in addition, the media message subsystem table 126 cross-references locally stored media messages to media units storing the messages. In another aspect, the media unit 106 may be equipped with a printed screen image that is not easily updated, and in this case the selection of a particular message automatically selects the media unit associated with the non-updatable message. Alternatively, a digital display unit may be tasked with presenting locally stored media if there is a communication problem preventing the downloading of media messages. As shown in FIG. 1C, the message “eLux Displays” is associated with drone #2, whereas the other messages from the message table 126 are updatable (in a digital format) and can be transmitted to a number of media units. Note that the media units to be associated with the updatable messages have yet to be selected in this example. Optionally, the media message subsystem 124 may accept media message selections from a user permitting the user to add (e.g., upload) a media message to the message table 126.

As shown in FIGS. 1A and 1D, the system may further comprise a calendar subsystem 128 with a time table 130 listing a plurality of times. The time table 130 accepts time selections and supplies a selected time to the media unit 106. For simplicity, the time table is shown only being cross-referenced to a location selection, but it should be understood that timing selections may be further cross-referenced to media units and media messages. Although not shown in these views, the time selections may also be cross-referenced to particular media units, messages, valuations (see below), and media unit types (see below).

As shown in FIGS. 1A and 1E, in some aspects the system may further comprise a targeting subsystem 132 with a valuation table 134 cross-referencing geographic locations to weighted values. The valuation table 134 accepts the geographic location selection (site selection) and supplies a reward calculation in response to the selected geographic location. In addition to location, the reward calculation may also be responsive to considerations such as time, media message, local environment, and media unit type. As explained in more detail below, local environment factors may be measured and reported back to the targeting subsystem. The factors may include consideration outside the scope, or incorrectly perceived by geo-fencing, or may be temporary conditions (a blocked street or an unexpected crowd of people). In one aspect a negotiation subsystem 146 comprises a tasking interface to debit a user in response to the weighted value of the selected geographic location, as well as a user interface to credit the media unit in response to the determined reward.

As shown in FIGS. 1A and 1F, the system may further comprise a platform subsystem 136 with a media unit table 138 listing a plurality of media unit types. The media unit table 138 accepts a media unit type selection and supplies a media unit enablement signal to a selected media unit type. It should be noted that some particular locations might be tied to a particular media unit type. For example, returning to FIG. 1B briefly, 1492 Ash Street is linked to billboard #6. However, that does not necessarily mean that a mobile media unit cannot be parked (in front of billboard #6) at the same address. As used herein, a mobile platform is “parked” if stationary, typically with its engine (if so equipped) shut off. Mobile platforms may be “parked” along city streets or in publicly accessible areas, such as parking lots. It should also be noted that other locations may be already occupied by a mobile media unit, so that the user will not be able to select a different type of media unit for that location. Mobile platforms are only “parked” for limited durations of time, typically a matter of hours, but the durations can be as small as minutes or larger than even weeks. More generally, the media unit type may refer to size of a billboard and/or whether the billboard has digital capabilities to accept message updates or new messages. Otherwise, the media unit type may refer to a type of automobile or the screen size capabilities of an automobile, drone aircraft or boat, or the style of boat. Another type of media unit is a portable billboard, such as a sandwich board. The selection of the media unit type may inherently entail the automatically selection of the particular message projection means enabled by the particular media unit.

FIG. 1G is diagram depicting the combination of all the above described selection categories as associated with a particular user. It should be understood that while user tables and site selection tables have been used as the basis for FIGS. 1B through 1G, the system need not use all the tables described above, and the user table can be referenced against different combinations of site selection, message, time, valuation, and media unit type tables. It should be understood that although the above-mentioned tables have been described as separate entities, in some aspects they may be combined into a single table.

As explained in more detail below, the media units are typically enabled with a communication subsystem having the ability to accept the media unit enablement signal from the media distribution clearinghouse 100. Further, each media unit typically includes a media projection subsystem for projecting the selected media message. It is also typical, such as is in the case with mobile media units, that the media units further may comprise a location subsystem to determine the geographic location of the media unit, so that the communication subsystem is able to transmit the geographic location, thus verifying that the media unit is positioned at a selected geographic location. The media unit communication subsystem may further comprise a publically accessible cellular telephone local booster, publically accessible Internet booster, and/or a publically accessible access point (AP), such as an IEEE 802.11 Wireless Local Area Network (WLAN) AP, an IEEE 802.15 Wireless Personal Area Network (WPAN) AP, or combinations thereof.

Without imposing limitations on the system, some examples of media unit media projection subsystems include an image projector, a retractable screen, a topper, a liquid crystal display, LED display, holographic display, a light emitting diode display, wallscape, electroluminescent (EL) display, switchable glass displays, persistent image fan, or combinations thereof.

As would be understood in the art, the computer system 140 hosting the clearinghouse 100 would comprise the processor 112 cooperating with software applications in non-transitory local memory 110. The non-transitory memories described herein may be any type or form of non-volatile storage device or medium capable of storing data and/or other computer-readable instructions. Examples of memories include, without limitation, Read Only Memory (ROM), flash memory, or any other suitable memory device. Although not required, in certain embodiments, the system described herein may include both a volatile memory unit and a non-volatile storage device. The memory may be implemented as shared memory and/or distributed memory in a network device.

As is common in many computer systems or servers, processor 112 is connected to the bus line 116 to pull operating instructions from operating system 114 and software applications in memory 110, and manage communications between the various components of computer. For ease of understanding, the above-described functions have been described as individual components. However, it should be understood that in practice, multiple functions may be performed by a single device, subsystem, or software application. It should be understood that computer systems are well understood by persons with ordinary skill in the art, and in the interest of brevity, details of their operation have been omitted.

For convenience, all the components associated with computer/server 140 are shown embedded as a single schematic block, but it should be understood that these components are not necessarily embedded in a single hardware unit or server, or in communication with each other. Alternatively, the software applications may be cooperating components of an overall software system. The server may also represent a network of servers in communication with each other.

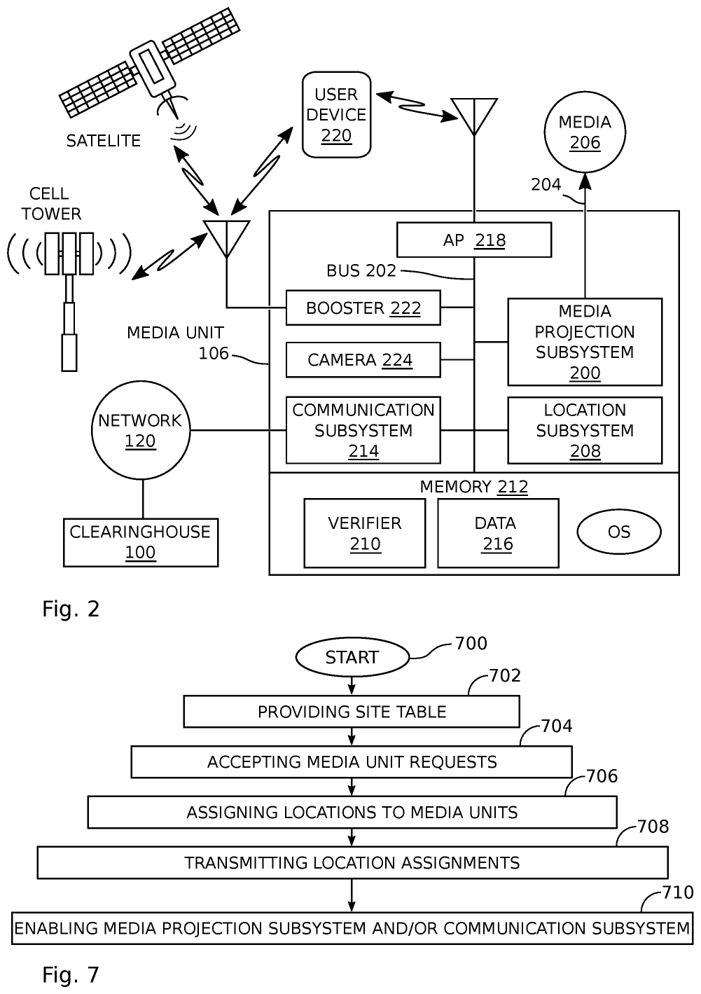

FIG. 2 is a schematic block diagram depicting an exemplary media unit. The media unit described below includes a number of functions and services. It should be understood that the media unit need not incorporate all the services described below. In one aspect, the media unit comprises a media projection subsystem 200, which may be selectively engaged in cooperation with the media distribution clearinghouse 100, and which may supply an enablement signal (enablement acknowledgement) on bus line 202 when enabled. The media projection subsystem 200 has an interface, represented by reference designator 204, to project a form of media 206. As noted above, some examples of the media projection subsystem 200 include an image projector, a topper, a retractable screen, an LCD or LED TV monitor type display, a wallscape, holographic display, switchable glass display (such as made by Gauzy), and combinations thereof. For example, a screen deployment mechanism may wrap and unwrap a flexible screen material around a roller. The media projection subsystem 200 is not limited to any particular type of projection means, screen material, or deployment means. The media projection subsystem 200 may alternatively be engageable to project an image onto the deployed viewing screen. The media projection subsystem 200 may also broadcast audio messages, or a combination for audio and visual messages.

The media projection subsystem 200 may be an image projector enabled as a liquid crystal (LC) or LED display similar to a home theater type video projector. Alternatively, high performance (e.g., mercury arc or xenon arc) lamps, cathode ray tube (CRT), digital light processing (DLP), plasma, silicon X-tal reflective display (SXRD), or red-green-blue (RGB) lasers may be used. In other words, the media projection subsystem 200 may present a 2-dimensional or 3-dimensional image, which may or may not be transitory. Transitory images include a series of still images, videos, or combinations thereof.

The media projection subsystem 200 may also include an internal battery and/or cables for attachment to an external power source. The media projection subsystem 200 typically includes miscellaneous electronic circuitry required to support the major components described herein, as would well understood in the art. The media projection subsystem 200 may include components for attachment to a wall, window, or balcony, or a stand for mounting on a sidewalk or lawn.

Typically, the media unit 106 further comprises a location subsystem 208 having an output on line 202 to supply a geographic location of the media projection subsystem. Note, in the case of stationary billboards, the location subsystem may not be necessary. Examples of a location subsystem 208 include a Global Positioning Satellite (GPS) system receiver, assisted GPS taking advantage of cell tower data, a Wireless Local Area Network IEEE 802.11 (WiFi) positioning system, cell-site multilateration, satellite multilateration, or a hybrid positioning system. Hybrid positioning systems find locations using several different positioning technologies, such as GPS, combined with cell tower signals, wireless internet signals, Bluetooth sensors, IP addresses, and network environment data. Cell tower signals have the advantage of not being hindered by buildings or bad weather, but usually provide less precise positioning. WiFi positioning systems may give very exact positioning in urban areas with high WiFi density, depending on a comprehensive database of WiFi access points. Further, a LORAN type system or LoJack® type system might be adapted for the purpose of location determination. As noted in U.S. Pat. No. 10,796,340, which is incorporated herein by reference, camera images and the location data of proximate smartphones, laptops, and personal communication devices can also be used to determine location.

Optionally, the media unit 106 may further comprise a verifier, or verification subsystem, 210 with an interface on line 202. Here, the verifier 210 is enabled as a software application stored in local non-transitory memory 212, including processor executable instructions to receive the enablement (enablement acknowledge) signal, an identification code, the geographic location, to supply verification information responsive to the enablement signal, the identification code, the geographic location, and the media being projected. The determination of location may involve determining if the media unit is stationary or in motion, or durations of time the mobile unit is stationary or in motion. Alternatively, at least some components of the verifier 210 may be enabled in hardware. As another alternative, some software modules of the verifier may be stored in the non-transitory memory of the media distribution clearinghouse 100.

The media unit typically includes a communications subsystem 214. The communications subsystem 214 has an interface on line 202 to accept verification information and an interface to communicate the verification information, if so enabled. As shown, the communications subsystem is in communication with network 120. In the case of a mobile media unit, the communications subsystem 214 may be a wireless transceiver. The most typical examples of a wireless communication subsystem 214 are cellular systems (e.g., Global System for Mobile Communications (GSM), Universal Mobile Telecommunications System (UMTS)-time division duplexing (TDD), Long-Term Evolution (LTE), 4^{th} Generation (4G), or 5^{th} Generation (5G)), and the like. Less typically, the communications subsystem 120 may be enabled with WLAN IEEE 802.11 (WiFi), or even Long Range Wireless transceiver. Some examples of a Long Range Wireless system include Digital Enhanced Cordless Telecommunications (DECT), Evolution-data Optimized (EVDO), General Packet Radio Service (GPRS), High Speed Packet Access (HSPA), IEEE 802.20 (iBurst), Multichannel Multipoint Distribution Service (MMDS), Muni WiFi, commercial satellite, and IEEE 802.16 Worldwide Interoperability for Microwave Access (WiMAX (WiBro)). As another alternative, the communication subsystem may store verification information and other communication messages in the system local memory 212 as data 216, which may be periodically downloaded using a wireless or hardwire connection. In the case of a stationary media unit, the communications subsystem may also be an Ethernet connection. The media unit 106 is not limited to any particular type of communication subsystem. In one aspect, the communications subsystem 214 receives media uploads from the clearinghouse 100, which it provides to the media projection subsystem 200, for presentation.

The targeting subsystem supports the selection media projection subsystem target locations by assigning corresponding location values. As shown, the targeting subsystem is enabled as software application stored in server memory. Alternatively, at least portions of the media distribution clearinghouse 100, including the targeting subsystem, can be stored in the media unit 106 local memory 212, or with the user device. In some variations the targeting subsystem may be enabled with hardware, or even as a hardcopy list manipulated by a human operator. In one aspect of the clearinghouse system 100, a rewards subsystem, which may alternatively be considered a sub-module of the targeting subsystem, requests or provides a reward to an entity, depending on whether the entity is requesting or providing the media service. The entities involved may include the entity managing the clearinghouse, the user making the media-related selections, the entity managing the media unit, an entity owning the property upon which the media projection subsystem is located, or combinations of the above-mentioned entities. As used herein, an “entity” may be a person, a business, a corporation, any type of social organization or business unit, a physical device, or a software application. For simplicity, the entities may be identified as the hardware components being used by, or associated with a business, person, corporation, or social organization. In this case, the entity may be described as a computer, smartphone, media projection subsystem, server, or vehicle, to name a few examples.

In another aspect, the media unit 106 further comprises a publically accessible access point (AP) 218. The AP 218 may be an IEEE 802.11 Wireless Local Area Network (WLAN), such as a WiFi hotspot, an IEEE 802.15 Wireless Personal Area Network (WPAN), such as Bluetooth access point, or both a WLAN and WPAN access point, connected to antenna 132. Alternatively, but less common, the access point 218 may an IEEE 802.15.4 Zigbee, WPAN IEEE 802.15 Li-Fi or wireless USB device. Even more unlikely as an access point are Long Range Wireless systems. In the case of the WiFi or Bluetooth access point being a component of the communications subsystem 214, items 214 and 218 may be collocated. As used herein, a “publically accessible” AP is an AP that can be accessed by the general public without a password or similar security measures, or where the password is publically distributed. One example of a publically accessible AP is the WiFi hotspot service provided by a typical Starbucks coffee shop. In the case of a password being required for access, the password may be printed on the mobile platform, displayed by the media projection subsystem, or made available through a media projection phone application or website.

A number of ways are known in the art for measuring the effectiveness of radio frequency (RF) communications, which can be used to enable the measurement communication statistics. Some examples include the measurement of bit error rate (BER) and signal strength. There are two basic links involving the AP 218. One link is between the AP 218 and the communications subsystem 214. The other linkage is between the AP 218 and user devices 220, such as smartphones, laptops, and personal communication devices.

In one aspect, the access point 218 and/or communications subsystem 214 can be used to collect data from entities passing by, or engaging with the access point or using the communications subsystem. This data can be stored in local memory 212 for subsequent recovery or transmitted to the server in support of data gathering or geo-fencing data. In support of data mapping, the access point is publically accessible to user devices (e.g., 220) that include smartphones, personal devices, or generally any type of computing device. Typically, the user devices are enabled for WiFi and Bluetooth communications. If left enabled, as is the typical case for many users, the user device is able to interact with a nearby access point even if a communication data link is not established. As used herein, the term data mapping includes the collection of data from the user devices. In one aspect, user data information (e.g., addresses) is collected voluntarily, with the user explicitly agreeing to data collection in response to an access point provided services, such as the provision of an Internet browser, email, Internet, or social media services. For example, if the access point 218 is a WiFi hotspot that accepts Uniform Resource Locator (URL) address requests from a user device (e.g., a smartphone), the URL address requests may be transmitted to a Domain Name System (DNS) service embedded with the computer system hosting the clearinghouse 100. The DNS service makes address searches. Otherwise, the information is collected without an explicit agreement by the user, where legal. Rewards to entities may be based upon the volume of traffic through the WiFi hotspot or access point data collected. In some aspects, camera images, in cooperation with a facial recognition software application (e.g., DeepFace), are used for data tracking.

In another aspect, the media unit may include a signal booster 222, such as a device provided by WeBoost, or a similarly functioning proprietary device. The booster 222 may act as a relay between a proximately located user cellular device 220 and a cellular network (i.e., base station or satellite). In other aspects, the signal booster 222 acts to relay Internet signals, such as might be useful when employed with the StarLink Internet service, as the StarLink ground units require an uninterrupted view of the sky (i.e., view of the StarLink satellites) For example, the media unit may be positioned in areas of weak cellular coverage. Using the site selection and targeting components mentioned above, mobile media units can be directed to, and rewarded for established cellular boosters in poor coverage areas. Improved cellular coverage necessary improves Internet and WiFi services carried by the cellular service.

The media unit 106 may include a camera 224 to record images of the geographic location proximate to the media unit. The camera images may be stored in local memory 212, or the communications subsystem 214 may transmit the images. In one aspect, the camera may also be used to modify the value of the target location, as explained in more detail below. For example, the recorded traffic in a location may be greater than anticipated, and the weighted value adjusted accordingly. That is, images recording higher pedestrian or vehicular traffic may indicate, at least temporarily, a greater location value. The data may be used to help determine the efficacy of the media or location. Alternatively or in addition, the camera images my act to verify that the media projector subsystem 200 has been enabled, media unit movement, or lack thereof, or identification of a particular location. In one aspect, simply recording a change in images, and thus proximate traffic, can be used as a means for proving media projector subsystem enablement. As an alternative, or in addition to the camera, the system may further comprise a proximity detector subsystem to sense nearby motion, or to measure the density of proximate vehicular or foot traffic, which data is transmitted by the communications subsystem or recorded in local memory.

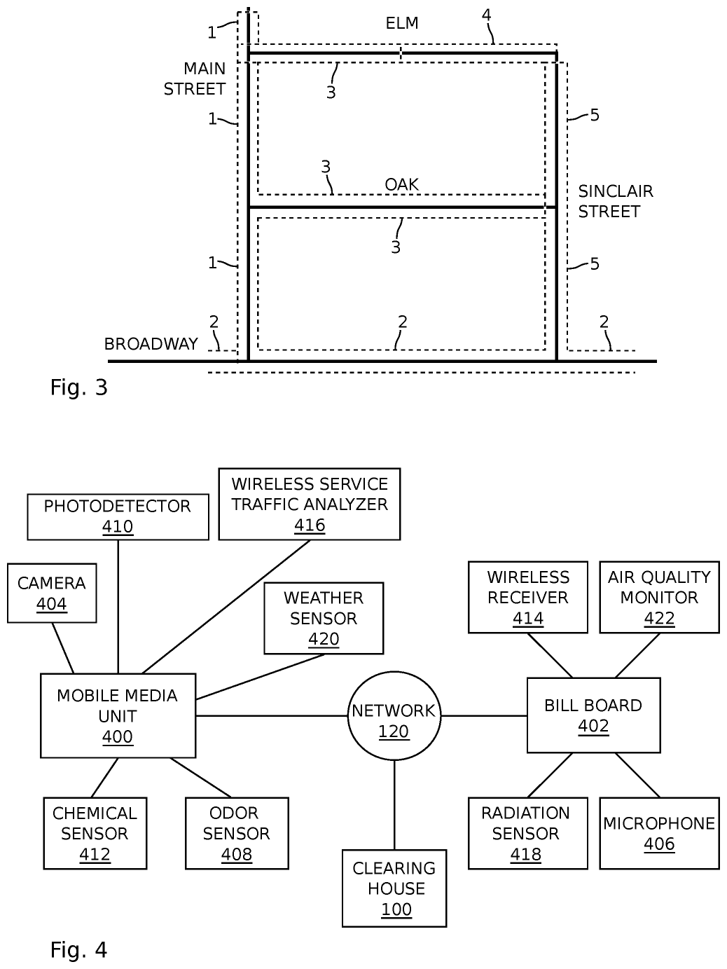

FIG. 3 is a plan view of geographic regions cross-referenced to the weighted value of various positions. As shown, regions along Main Street have a value of 1, the highest rated value. The regions along Broadway have a value of 2. The regions along Oak have a value of 3. The region along Elm near Main Street have a value of 3, which decreases to a value of 4 near Sinclair Street, and the regions along Sinclair Street have a value of 5.

The systems described above can be adapted for use in a model where an advertiser or commercial entity pays for service based upon performance. For example, a media user (client) may connect to the clearinghouse stipulating a target market and deployment hours/rate. The system provider (intermediary organization) determines geo-fenced locations that meet or exceed the media user's target market based on location, demographics, traffic, population density, and other variables. Platform deployment time, location, quality code, and user information are recorded by the clearinghouse. The clearinghouse may determine platform performance based on length of deployment, contracted rate, maintenance cost reimbursement, and location quality code.

For example, the deployment of the sign along a busy urban thoroughfare is likely to have a greater value than deployment on a suburban side-street. Other factors that may be used to calculate target value may include the time of day and the length of deployment. Other key features of the system are determining that the display and/or access point have actually been deployed, and once deployed, the location of the system.

FIG. 4 is a schematic block diagram depicting a system for location value weighting. Weighted values in the targeting subsystem valuation table (see FIGS. 1A and 1E) are typically established using geo-fencing services, such as provided by Radar Labs, Inc. Geo-fencing uses technologies like GPS, radio frequency identification (RFID), WiFi, cellular data, and internet protocol (IP) address ranges, to build virtual fences in geographic regions. These virtual fences can be used to track the physical location of a device (e.g., smartphone) active in the particular region or the fence area. The location of the person using the device is taken as geocoding data and can be used construct a picture of IP traffic in those areas. However, the geo-fencing information used to support the above-described valuation table is typically not instantaneously updated. To support instantaneous real-time updates, the valuation table may receive geographic location local environmental data from network-connected media units. Either or both mobile media unit 400 and billboard 402 are able to supply local environmental data from a camera 404, microphone 406, odor sensor 408, photodetector 410, chemical sensor 412, wireless spectrum receiver 414 (e.g., detecting the noise floor in Bluetooth, WiFi, or cellular bands), wireless service traffic analyzer 416 (e.g., detecting traffic through a publically accessible AP or the above-mentioned geo-fencing technologies), radiation sensor 418, local weather sensor 420 (e.g., temperature or rain), and/or air quality monitor 422.

Returning to FIG. 1A, in some aspects the site selection subsystem further comprises a manager 142 for accepting mobile media unit on-duty notifications and assigning geographic parking locations to mobile media units in response to the on-duty notifications. As shown in FIG. 2, the mobile media unit 106 location subsystem 208 determines the mobile media unit location, and the communication subsystem 214 receives an assigned geographic parking location (from the manager) and transmits the mobile media unit geographic location to the manager 142. The media projection subsystem 200 can thus be enabled at the assigned geographic parking location. In this aspect a user associated with mobile media unit 106 may transmit an on-duty notification with an assignment request for a first geographic parking location. The site selection subsystem manager 142 may assign the requested first geographic parking location to the media unit, or it may assign a different (i.e., second) geographic parking location. In one aspect, users (entities) associated with mobile media unit 106 and mobile media unit 144 may both transmit an on-duty notification with an assignment request for the same (first) geographic parking location. In this case the site selection subsystem manager 142 may make a decision choosing to assign the first geographic parking location to mobile media unit 106 (but not media unit 144). In some aspects the users associated media units 106 and 144 may bid for a desired parking location assignment, and successful bids may be used to offset weighted values and rewards. Alternatively, assignment priority may be based upon a quality rating system, with high performing media units having a higher priority. Although not specifically mentioned, the mobile media units may incorporate some or all the functions described in the explanation of FIG. 2. Likewise, the site selection subsystem described above may work in cooperation with the other components of the clearinghouse system described in the explanation of FIG. 1A.

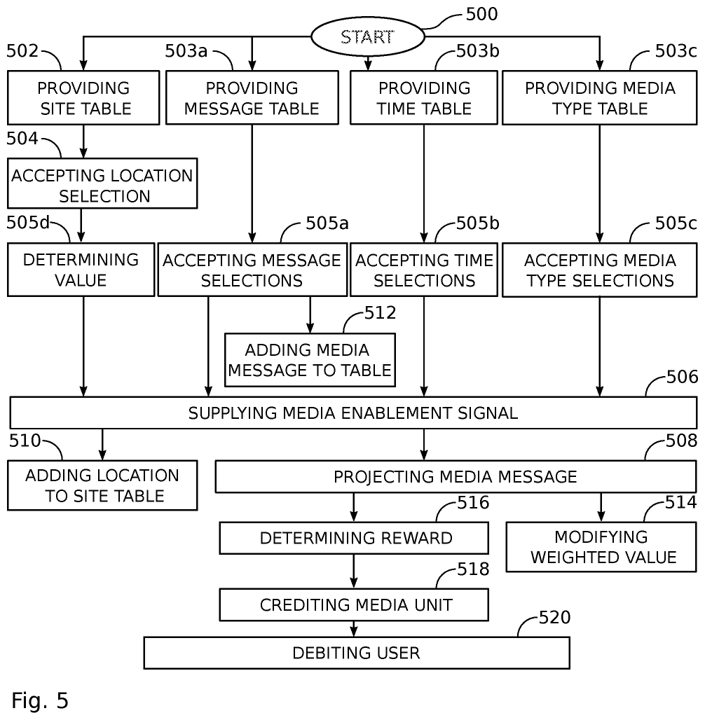

FIG. 5 is a flowchart illustrating a media distribution clearinghouse method. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method steps are supported by the above system descriptions and, generally, the method follows the numeric order of the depicted steps. The method starts at Step 500.

Step 502 provides a site table listing a plurality of potential geographic locations cross-referenced to media units. Step 504 accepts geographic location selections. Step 505d assigns a weighted value to the accepted geographic location. Step 506 supplies a media enablement signal to a media unit in response to the selected geographic location. Step 508 projects a media message from the selected geographic location. As described above, the site table may provide variable locations, fixed stationary locations, parking locations, predetermined travel routes, and non-predetermined travel routes. In one variation, in Step 510 a user may add a geographic location to the site table.

In one aspect, Step 503a provides a message table listing a plurality of media messages. Step 505a accepts media message selections. Then Step 506 supplies the media message enablement signal for a selected media message. In some aspects Step 505a may transmit the selected media message to the media unit, as might be the case if the media units are equipped with digital (updatable) media projection equipment. Otherwise, the media message table cross-references locally stored (non-updatable) media messages to media units. In one variation in Step 512 a user may add a media message to the message table.

Optionally, Step 503b provides a time table listing a plurality of times. Step 505b accepts time selections, and Step 506 supplies the media message enablement signal for a selected time. As another option, Step 503c provides a media unit table listing a plurality of media unit types. Step 505c accepts a mobile unit type selection, so that Step 506 supplies the media message enablement signal to a selected mobile unit type.

In one other aspect, Step 514 may modify the weighted value determined in Step 505d in response to factors such as time, media unit type, media message selections, and combinations thereof. Optionally, Step 516 determines a reward for the media unit in response to the weighted value of the geographic location. Step 518 credits the mobile unit with the reward and Step 520 debits the user interface the weighted value.

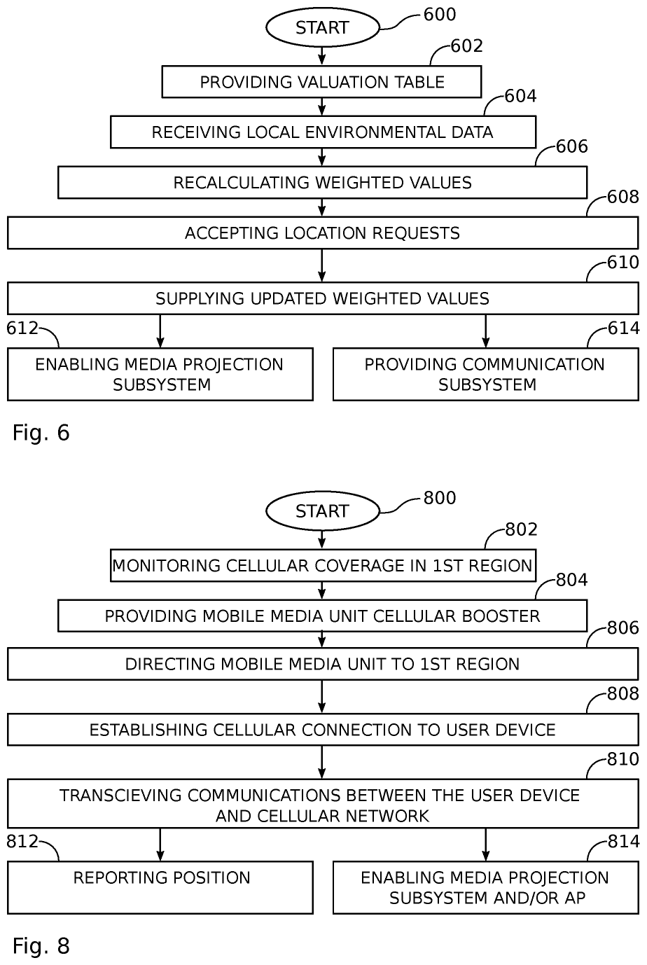

FIG. 6 is a flowchart illustrating a method for establishing location value weighting. The method begins at Step 600. Step 602 provides a valuation table cross-referencing geographic locations to weighted values. Step 604 receives local environment data. Some examples of local environmental data include images, sounds, smells, chemical analysis, wireless spectrum analysis, weather, wireless service traffic analysis, and radiation detection (see FIG. 4). Step 606 recalculates the weighted values in response to the local environmental data. In one aspect, Step 608 accepts geographic location requests for a media unit, and Step 610 supplies updated weighted values in response to the geographic location requests. Optionally, in Step 612, a media unit selectively enables a media projection subsystem at the requested geographic location. Alternatively or in addition, the media unit provides a communication subsystem such as a cellular telephone local booster, a publically accessible access point (AP), or combinations thereof.

FIG. 7 is a flowchart illustrating a method for assigning locations to mobile platforms. The method starts at Step 700. Step 702 provides a site table cross-referencing media units to geographic locations. In one aspect, the geographic locations are stationary or parking locations. Step 704 accepts media unit requests. Typically, the requests are from mobile media units, as described in detail above (FIG. 2). Step 706 assigns geographic parking locations to media units in response to the assignment requests. Step 708 transmits assigned geographic locations to media units. Step 710 enables a media projection subsystem and/or a communication subsystem at the assigned geographic location. In one aspect, Step 708 verifies the media unit location.

In one aspect, both a first media unit and a second media unit submit requests for the same (first) geographic location in Step 704. In Step 706, a decision is made to assign the first geographic location to the first media unit (but not the second media unit).

FIG. 8 is a flowchart illustrating a method for locally boosting cellular telephone network coverage. The method starts at Step 800. Step 802 monitors cellular telephone network coverage in a first region serviced by at least a first base station. Step 804 provides a mobile media unit with an attached publically accessible cellular telephone booster. In Step 806 a targeting subsystem directs the mobile media unit to a first geographic location in the first region. Step 808 establishes a cellular telephone connection between a cellular telephone equipped user device located in the first region or nearby the first region. Typically, the connection is established to the booster because the user device has a poor or non-existent connection to the first base station. In Step 810 the cellular telephone booster transceives cellular communications between the user device and the first base station. In one aspect the mobile media unit reports its geographic location in Step 812. In another aspect, in Step 814, the mobile media unit enables a media projection subsystem and/or a publically accessible AP at the first geographic location. Although not explicitly described, this method is also applicable to an Internet booster.

Systems and methods have been provided for a media distribution clearinghouse. Examples of particular message structures, schematic block linkages, and hardware units have been presented to illustrate the invention. However, the invention is not limited to merely these examples. Other variations and embodiments of the invention will occur to those skilled in the art.

We claim:

1. A media distribution clearinghouse system comprising:
a site selection subsystem comprising:
a site table listing a plurality of potential stationary locations;
a user interface to accept stationary location selections and a tasking interface to supply a media enablement signal to a media unit in response to the selected stationary location; and,
a targeting subsystem comprising a valuation table cross-referencing stationary locations to weighted values.

2. The system of claim 1 further comprising:
a media message subsystem comprising:
a message table listing a plurality of media messages; and,
a user interface to accept media message selections and a tasking interface to supply the media message enablement signal, for a selected media message, to the media unit.

3. The system of claim 2 wherein the media message subsystem tasking interface transmits the selected media message to the media unit.

4. The system of claim 2 wherein the media message subsystem table cross-references locally stored media messages to media units.

5. The system of claim 1 further comprising:
a plurality of media units selected from a group consisting of mobile media units, stationary media units, and combinations thereof.

6. The system of claim 2 further comprising:
a calendar subsystem comprising:
a time table listing a plurality of times; and,
a user interface to accept time selections and a tasking interface to supply a selected time to the media unit.

7. The system of claim 1 wherein the site table lists locations selected from a group consisting of variable locations, fixed stationary locations, predetermined travel routes, non-predetermined travel routes, and combinations thereof.

8. The system of claim 1 wherein the site selection subsystem user interface accepts geographic location submissions from a first user for addition to the site table.

9. The system of claim 2 wherein the media message subsystem user interface accepts media message submissions from a first user for addition to the message table.

10. The system of claim 1 wherein the targeting subsystem modifies a weighted value determination in response to additional considerations selected from the group consisting of time, local environment, media message, media unit type, and combinations thereof.

11. The system of claim 2 further comprising:
a platform subsystem comprising:
a media unit table listing a plurality of media unit types; and,
a user interface for accepting media unit type selections and a tasking interface to supply a media unit enablement signal to a selected media unit type.

12. The system of claim 2 further comprising:
a plurality of media unit types selected from the group consisting of ground vehicles, air vehicles, nautical vehicles, and stationary billboards, portable billboards, each media units comprising:
a communication subsystem having an interface to accept the media unit enablement signal; and,
a media projection subsystem for projecting the selected media message.

13. The system of claim 12 wherein the media units further comprise:
a location subsystem to determine the geographic location of the media unit; and,
wherein the communication subsystem transmits the geographic location to the site table.

14. The system of claim 12 wherein the communication subsystem further comprises a transceiver selected from the group consisting of a publically accessible cellular telephone local booster, a publically accessible Internet booster, and a publically accessible access point (AP) selected from the group consisting of an IEEE 802.11 Wireless Local Area Network (WLAN) AP, an IEEE 802.15 Wireless Personal Area Network (WPAN) AP, and combinations thereof.

15. The system of claim 12 wherein the media projection subsystem is selected from a group consisting of an image projector, a topper, a retractable screen, a liquid crystal display, holographic display, a light emitting diode display, wallscape, electroluminescent (EL) display, switchable glass displays, persistent image fan, and combinations thereof.

16. The system of claim 1 further comprising:
a negotiation subsystem comprising:
a tasking interface to debit a user in response to the weighted value of the selected geographic location; and,
a user interface to credit the media unit in response to the determined weighted value.

17. A system for establishing location value weighting, the system comprising:
a targeting subsystem comprising:
a valuation table cross-referencing geographic locations to weighted values;
an interface to receive geographic location local environmental data selected from the group consisting of a camera, microphone, odor sensor, photodetector, chemical sensor, wireless spectrum receiver, wireless service traffic analyzer, radiation sensor, weather sensor, air quality monitor, and combinations thereof; and,
wherein the targeting subsystem updates the weighted values in the valuation table in response to the geographic location local environmental data.

18. A media distribution clearinghouse system for assigning geographic locations to mobile media units, the system comprising:
a site selection subsystem comprising:
a site table cross-referencing mobile media units to geographic parking locations;
a manager for accepting mobile media unit on-duty notifications and assigning geographic parking locations to mobile media units in response to the on-duty notifications;
a mobile media unit comprising:
a location subsystem to determine the mobile media unit location;
a communication subsystem to receive an assigned geographic parking location and transmit on-duty notifications and the mobile media unit geographic location to the site table; and,
a media projection subsystem enabled at the assigned geographic parking location.

19. The system of claim 18 wherein a first mobile media unit transmits an on-duty notification with an assignment request for a first geographic parking location; and,
wherein the site selection subsystem manager assigns a geographic parking location to the first mobile media unit selected from the group consisting of the first geographic parking location and a second geographic parking location.

20. The system of claim 18 wherein a first mobile media unit transmits an on-duty notification with an assignment request for a first geographic parking location;
wherein a second mobile media unit transmits an on-duty notification with an assignment request for the first geographic parking location; and,
wherein the site selection subsystem manager makes a determination assigning the first geographic parking location to the first mobile media unit.

21. The system of claim 18 wherein the media projection subsystem is selected from the group consisting of a visual display, an auditory presentation, a publically accessible cellular telephone booster, a publically accessible Internet booster, a publically accessible access point (AP) selected from the group consisting of an IEEE 802.11 Wireless Local Area Network (WLAN) AP, an IEEE 802.15 Wireless Personal Area Network (WPAN) AP, and combinations thereof.

22. The system of claim 18 further comprising:
a targeting subsystem cross-referencing geographic parking locations to weighted values.

23. A signal booster system comprising:
a mobile platform;
a publically accessible service selected from the group consisting of a cellular telephone booster and an Internet booster attached to the mobile platform having an interface to transceive communications between proximately located user devices and a station selected from the group consisting of a cellular telephone base station and a satellite;
a location device to determine a geographic location of the mobile platform; and,
a communication subsystem having an interface transmit the mobile platform geographic location.

24. The system of claim 23 further comprising:
a media projection subsystem attached to the mobile platform selected from the group consisting of a visual display, an auditory presentation, and a publically accessible access point (AP) selected from the group consisting of an IEEE 802.11 Wireless Local Area Network (WLAN) AP, an IEEE 802.15 Wireless Personal Area Network (WPAN) AP, and combinations thereof.

25. The system of claim 23 further comprising:
a targeting subsystem permitting the selection a target geographic location from a plurality of value weighted target geographic locations.

26. The system of claim 23 wherein the mobile platform is selected from the group consisting of ground vehicles, air vehicles, nautical vehicles.
